(19) United States
(12) Patent Application Publication
(10) Pub. No.: US 2011/0032190 A1
(43) Pub. Date: Feb. 10, 2011

(54) INFORMATION INPUT APPARATUS AND INFORMATION INPUT METHOD

(75) Inventor: Tomotaka Takarabe, Sapporo-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/849,754

(22) Filed: Aug. 3, 2010

(30) Foreign Application Priority Data
Aug. 5, 2009 (JP) 2009-182191

(51) Int. Cl. G06F 3/02

(52) U.S. Cl. 345/169

(57) ABSTRACT

An information input apparatus which displays a plurality of buttons on a display unit, detects an indicated position by a positional coordinate detection unit arranged on the display unit to input information corresponding to the indicated button includes: an incorrect input judgment unit that judges whether information input when a first button among the plurality of buttons is indicated is incorrect input; an incorrect input reason specification unit that specifies a reason of the incorrect input based on an indicated region of the first button with respect to an indicatable region of the first button displayed on the display unit, when the incorrect input judgment unit judges that the input information is the incorrect input.

### BACKGROUND

1. Technical Field

The present invention relates to an information input apparatus and an information input method.

2. Related Art

Touch panels are widely used as an input apparatus included in various types of information processing apparatuses. Processings related to buttons displayed at touched positions are executed with the touch panel by touching a display screen with a user's finger. In recent years, a user frequently has pressed a wrong button when various settings are executed on one screen. This is because buttons displayed on a touch panel are smaller and spaces between adjacent buttons are narrower as functions of the information processing apparatus are diversified and made complex.

In order to reduce such a mistake that a user presses a wrong button, an information processing apparatus as described in JP-A-2009-93368 has been proposed. When a user presses a button at a wrong position, the information processing apparatus as described in JP-A-2009-93368 stores a difference between a pressed position and a correct press position to correct subsequent press positions based on the stored difference.

However, in the above information processing apparatus, although the press position is corrected, the size of buttons displayed on the display screen and spaces between the adjacent buttons are not changed. Therefore, it has been difficult to correctly press a desired button among buttons which are arranged close to each other.

### SUMMARY

An advantage of some aspects of the invention is to realize improving part of the above mentioned issues by the following embodiments or application examples.

### Application Example 1

An information input apparatus according to an aspect of the invention displays a plurality of buttons on a display unit, detects an indicated position by a positional coordinate detection unit arranged on the display unit to input information corresponding to the indicated button. The information input apparatus includes: an incorrect input judgment unit that judges whether information input when a first button among the plurality of buttons is indicated is incorrect input; an incorrect input reason specification unit that specifies a reason of the incorrect input based on an indicated region of the first button with respect to an indicatable region of the first button displayed on the display unit, when the incorrect input judgment unit judges that the input information is the incorrect input; and an enlargement display unit that enlarges and displays the buttons peripheral to the first button on the display unit in accordance with the reason of the incorrect input which is specified by the incorrect input reason specification unit.

With the configuration, when the input information is judged to be incorrect input, the information input apparatus specifies a reason of the incorrect input based on the indicated region of the first button with respect to the indicatable region of the first button displayed on the display unit. Then, the information input apparatus enlarges and displays the buttons peripheral to the first button on the display unit in accordance with the specified reason of the incorrect input. Accordingly, when the first button selected and indicated by the user among the buttons displayed on the display unit is an incorrect button, the user can press a desired button without fail because the user visually recognizes an image in which the button region peripheral to the first button is enlarged in accordance with the reason of the incorrect input.

### Application Example 2

In the information input apparatus according to the above application example, it is preferable that when an area center position of the indicated region is not included in the indicatable region of the first button, the enlargement display unit enlarge to display the buttons peripheral to the first button on the display unit.

### Application Example 3

In the information input apparatus according to the above application example, it is preferable that when the area center position of the indicated region is included in the indicatable region of the first button, the enlargement display unit should not enlarge to display the buttons peripheral to the first button on the display unit.

### Application Example 4

In the information input apparatus according to the above application example, it is preferable that when the indicated region overlaps with the indicatable region of the first button and an indicatable region of another button, the enlargement display unit enlarge to display the buttons peripheral to the first button on the display unit.

### Application Example 5

In the information input apparatus according to the above application example, it is preferable that when a ratio of an area of a region where the indicated region and the indicatable region of the first button are overlapped with each other with respect to an area of the indicated region is not larger than a predetermined ratio, the enlargement display unit enlarge to display the buttons peripheral to the first button on the display unit.

### Application Example 6

In the information input apparatus according to the above application example, it is preferable that the indicatable region of the button be divided into a plurality of regions. Further, in the information input apparatus, it is preferable that the enlargement display unit select the buttons peripheral to the first button in accordance with the region overlapping with the indicated region among the plurality of regions and enlarge and display the selected buttons on the display unit.

With this configuration, the buttons peripheral to the first button can be selected in accordance with the region indicated by the first button so as to enlarge and display the selected buttons on the display unit.

### Application Example 7

It is preferable that the information input apparatus according to the above application example include a storage unit that stores pieces of information relating to a plurality of the first buttons which are sequentially indicated among the plurality of buttons in chronological order.

With this configuration, pieces of information relating to the indicatable regions of the plurality of first buttons which are sequentially indicated among the plurality of buttons can be stored in chronological order.

### Application Example 8

An information input method according to another aspect of the invention displays a plurality of buttons on a display unit, detects an indicated position by a positional coordinate detection unit arranged on the display unit to input information corresponding to the indicated button. The information input method includes: an incorrect input judgment step for judging whether information input when a first button among the plurality of buttons is indicated is incorrect input; an incorrect input reason specification step for specifying a reason of the incorrect input based on an indicated region of the first button with respect to an indicatable region of the first button displayed on the display unit, when the input information is judged to be incorrect input in the incorrect input judgment step; and an enlargement display step for enlarging and displaying the buttons peripheral to the first button on the display unit in accordance with the reason of the incorrect input which is specified in the incorrect input reason specification step.

With the method, when the input information is judged to be incorrect input, the information input apparatus specifies a reason of the incorrect input based on the indicated region of the first button with respect to the indicatable region of the first button displayed on the display unit. Then, the information input apparatus enlarges and displays the buttons peripheral to the first button on the display unit in accordance with the specified reason of the incorrect input. Accordingly, when the first button selected and indicated by the user among the buttons displayed on the display unit is an incorrect button, the user can press a desired button without fail because the user visually recognizes an image in which the button region peripheral to the first button is enlarged in accordance with the reason of the incorrect input.

### BRIEF DESCRIPTION OF THE DRAWINGS

The invention will be described with reference to the accompanying drawings, wherein like numbers reference like elements.

FIG. 1 is a block diagram illustrating a functional configuration of an information input apparatus according to an embodiment of the invention.

FIG. 2 is a diagram illustrating a hardware configuration of the information input apparatus according to the embodiment of the invention.

FIG. 3 is a diagram illustrating a configuration of a touch panel input apparatus.

FIG. 4 is a diagram illustrating an initial screen.

FIGS. 5A, 5B and 5C are diagrams illustrating touch patterns of character input keys.

FIG. 6 is a diagram illustrating a position detection of a character input key touched.

FIG. 7 is a diagram illustrating a key enlargement display screen.

FIG. 8 is a flowchart illustrating a flow of processing in the information input apparatus according to the embodiment of the invention.

### DESCRIPTION OF EXEMPLARY EMBODIMENTS

Hereinafter, an information input apparatus will be described with reference to drawings.

### Embodiment

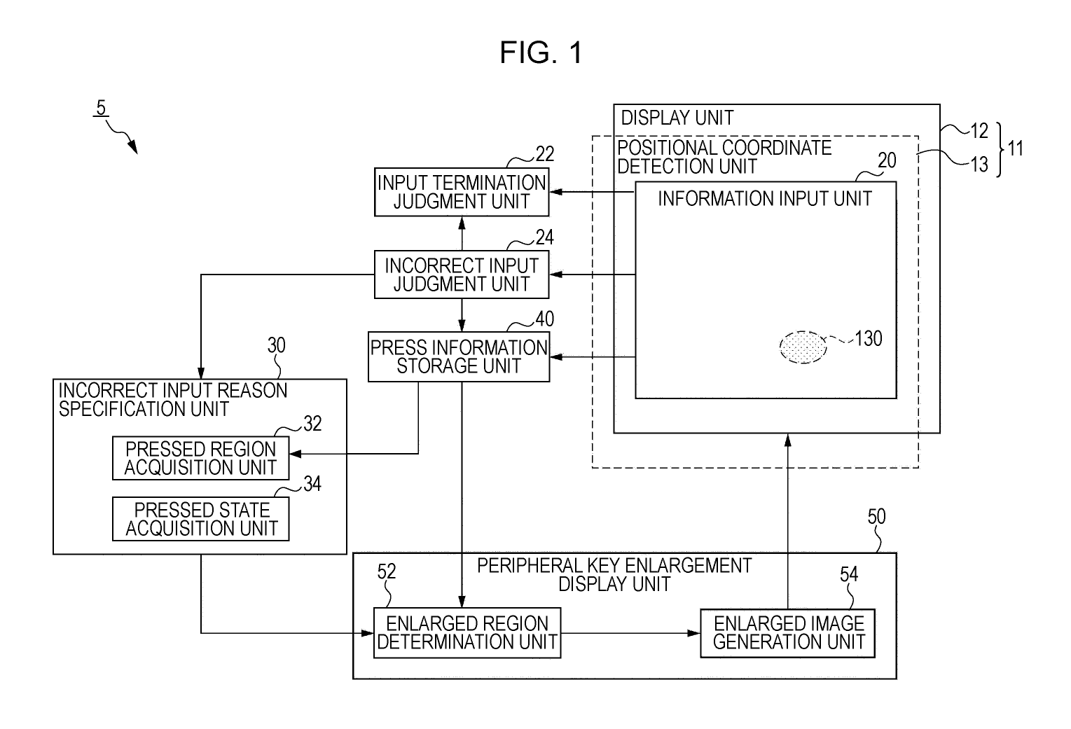

FIG. 1 is a block diagram illustrating a functional configuration of an information input apparatus 5. The information input apparatus 5 includes a display unit 12, a positional coordinate detection unit 13, an information input unit 20, an input termination judgment unit 22, an incorrect input judgment unit 24, an incorrect input reason specification unit 30, a press information storage unit 40, and a peripheral key enlargement display unit 50. The incorrect input reason specification unit 30 includes a pressed region acquisition unit 32 and a pressed state acquisition unit 34. The peripheral key enlargement display unit 50 includes an enlarged region determination unit 52 and an enlarged image generation unit 54. Further, the display unit 12 and the positional coordinate detection unit 13 constitute a touch panel input apparatus 11. It is to be noted that hardware and software which will be described later cooperate with each other so as to realize each function of the functional units. In the embodiment, the information input apparatus 5 is incorporated into an operation panel of an information processing apparatus such as a printer, a fax machine, an automated teller machine (ATM) and a personal digital assistant (PDA). Further, the information input apparatus 5 provides a user interface function in which a direction corresponding to a touched position is input when a user presses (touches) with a finger.

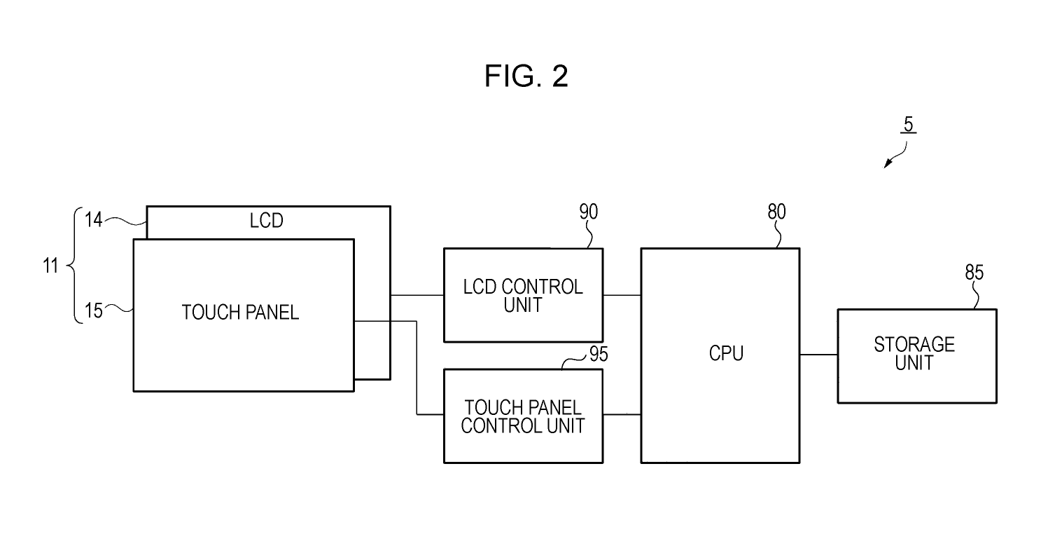

FIG. 2 is a diagram illustrating a hardware configuration of the information input apparatus 5. Hardware of the information input apparatus 5 includes a central processing unit (CPU) 80, a storage unit 85, an LCD control unit 90, a touch panel control unit 95, a touch panel 15 and a liquid crystal display (LCD) 14. The touch panel 15 and the LCD 14 constitute the touch panel input apparatus 11.

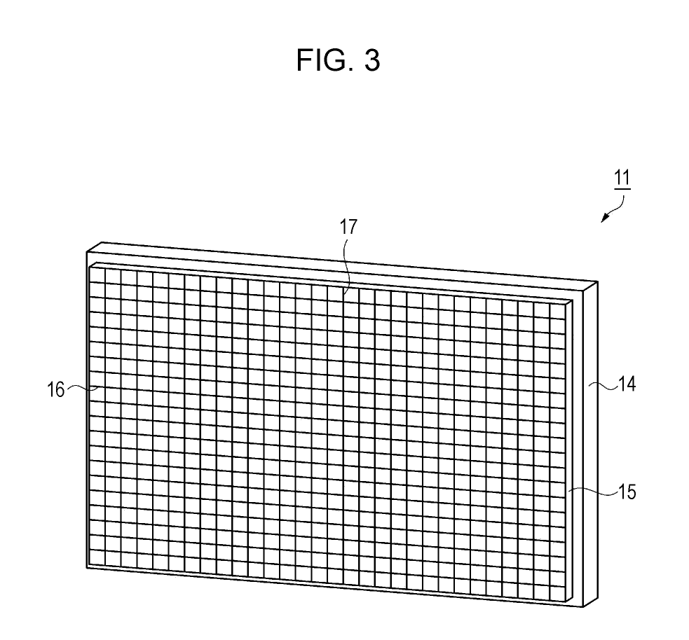

FIG. 3 is a diagram illustrating a configuration of the touch panel input apparatus 11. As is well-known, a transparent touch panel 15 is arranged on a surface of the LCD 14 on which an image is displayed so as to have a predetermined positional relationship with the LCD 14. A number of X axis electrode lines 16 are arranged in parallel in a transverse direction on the surface of the touch panel 15. Further, a number of Y axis electrode lines 17 are also arranged in parallel in a longitudinal direction on the surface of the touch panel 15. When a user touches the X axis electrode lines 16 and the Y axis electrode lines 17 with a finger, voltage drops are caused on the electrode lines. A position on the touch panel 15 where the user touches with a finger is detected based on positions of the X axis electrode lines 16 and the Y axis electrode lines 17 where the voltage drops are caused. For example, when the voltage drops are caused on three X axis electrode lines 16 and three Y axis electrode lines 17, an intersection of both middle electrode lines is assumed to be a touched position with a finger.

Note that the touch panel according to the embodiment is an example of the positional coordinate detection unit 13 and is not limited to the above matrix switch type touch panel. The touch panel according to the embodiment may employ various types such as a resistive film type, a surface acoustic wave type, an infrared-ray type, an electromagnetic induction type, a capacity type or the like. Further, an indication method is not limited to a finger and a stylus pen may be used for indication.

As described above, the information input apparatus 5 is an apparatus which allows a user to input information through the touch panel 15. In the embodiment, the LCD control unit 90 displays a user interface screen (UI screen) such as the information input unit 20 on the LCD 14 in accordance with an instruction from the CPU 80. The LCD 14 is an example of the display unit 12, and a display method and a display medium are not limited thereto. A desired region of the UI screen displayed on the LCD 14 is touched by the user with a finger so that the touch panel control unit 95 calculates positional coordinates of the touched position on the surface of the touch panel 15. Then, the touch panel control unit 95 inputs the calculated positional coordinates to the CPU 80 so that the CPU 80 executes a function corresponding to the positional coordinates.

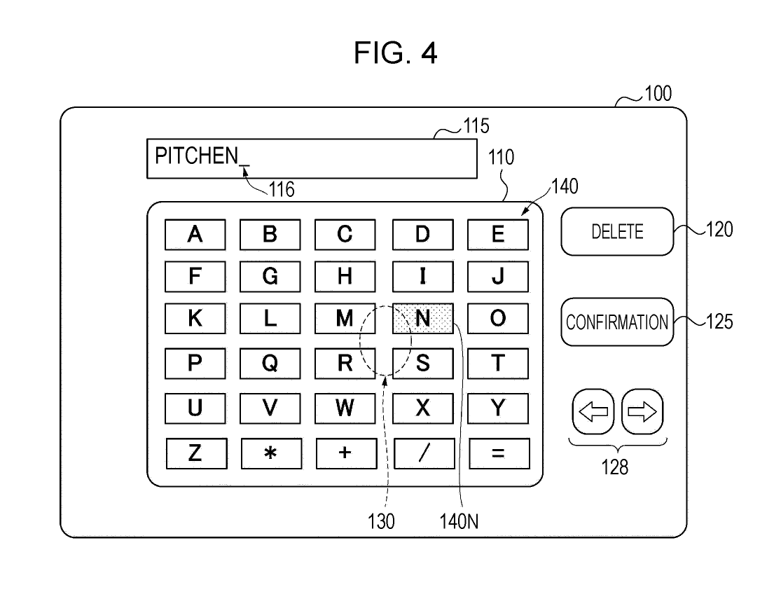

Next, details of the functional units of the information input apparatus 5 are described with reference to FIG. 1. The information input unit 20 is an input unit which allows a user to input information. In the embodiment, the information input unit 20 corresponds to an initial screen 100 which is initially displayed on the display region of the touch panel input apparatus 11 as shown in FIG. 4. A plurality of character input keys 140 are arranged on a key input region 110 at the center portion of the initial screen 100. These character input keys 140 are buttons which allow the user to input characters. In the embodiment, the character input keys 140 correspond to alphabets and special symbols. Displayed characters and symbols are related to the keys, respectively.

A display region 115 on which characters input by the character input keys 140 are sequentially displayed is arranged above the key input region 110. A delete key 120, a confirmation key 125 and direction instruction keys 128 are arranged on the right side of the key input region 110. FIG. 4 illustrates a touch region 130 touched by the user. The touch region 130 is a center portion of an “M” key, an “R” key, an “N” key and an “S” key of the character input keys 140 in FIG. 4. In this case, “N” is displayed at the end of a character string displayed on the display region 115 on the assumption that the “N” key is touched as an incorrect input key. When the character input keys 140 in the key input region 110, the delete key 120, the confirmation key 125 and the direction instruction keys 128 are touched by the user, the positional coordinate detection unit 13 detects a position of the touched region 130. Then, information indicating that the key has been touched is transmitted to the input termination judgment unit 22, the incorrect input judgment unit 24, or the press information storage unit 40 depending on the detected position.

Referring again to FIG. 1, the incorrect input judgment unit 24 judges whether information input by the user is incorrect input. In the embodiment, the incorrect input judgment unit 24 corresponds to the delete key 120 on the initial screen 100. The user touches the delete key 120 to delete the character “N” which is input by the character input key 140 and is displayed before a cursor 116 on the display region 115. This leads the incorrect input judgment unit 24 to judge that the character “N” is incorrectly input. When the incorrect input judgment unit 24 judges the incorrect input, the incorrect input judgment unit 24 transmits information relating to the incorrect input judgment to the incorrect input reason specification unit 30. It is to be noted that the incorrect input judgment unit 24 is not limited to the delete key 120 and can be supposed to be a “Delete” key or a “BackSpace” key. Further, the position of the cursor 116 can be moved in accordance with the direction instruction keys 128. Therefore, the incorrectly input character is not limited to the character at the end of the character string displayed on the display region 115. That is, the user can specify an arbitrary character on the character string as the incorrectly input character.

The input termination judgment unit 22 judges whether input by a user is terminated. In the embodiment, the input termination judgment unit 22 corresponds to the confirmation key 125 on the initial screen 100. The user touches the confirmation key 125 to confirm the character string which is input by the user and is displayed on the display region 115. Then, the process proceeds to a subsequent process. Further, the input termination judgment unit 22 may be an “Enter” key for confirming input.

The press information storage unit 40 stores pressed position information relating to the position of the touched region 130 which has been touched in the key input region 110. The pressed position information stored by the press information storage unit 40 is kept until the character string input is confirmed by the input termination judgment unit 22. The pressed region acquisition unit 32 and the enlarged region determination unit 52 refer to the pressed position information if needed.

The incorrect input reason specification unit 30 specifies a reason of the incorrect input based on the touched region 130 with respect to an indicatable region of the character input key (first button) 140N corresponding to the incorrectly input character (N). To be more specific, the pressed region acquisition unit 32 acquires information relating to the position of the touched region 130 touched when the character (N) is incorrectly input, from the press information storage unit 40. The acquired information relating to the position of the touched region 130 is transmitted to the pressed state acquisition unit 34.

The pressed state acquisition unit 34 acquires a pressed state of the character input key 140N based on the information relating to the position of the touched region 130 and information relating to a shape and the position of the character input key 140N. Note that the information relating to the position of the touched region 130 is transmitted from the pressed region acquisition unit 32, and the information relating to the shape and the position of the character input key 140N is stored in the storage unit 85. The incorrect input reason specification unit 30 specifies a reason of the incorrect input based on the pressed state of the character input key 140N acquired by the pressed state acquisition unit 34.

In the embodiment, if the pressed state of the character input keys 140 is any one of the following three patterns, the reason of the incorrect input is assumed that the size of the character input keys 140 is small or the arrangement spaces therebetween are narrow.

### Pattern 1

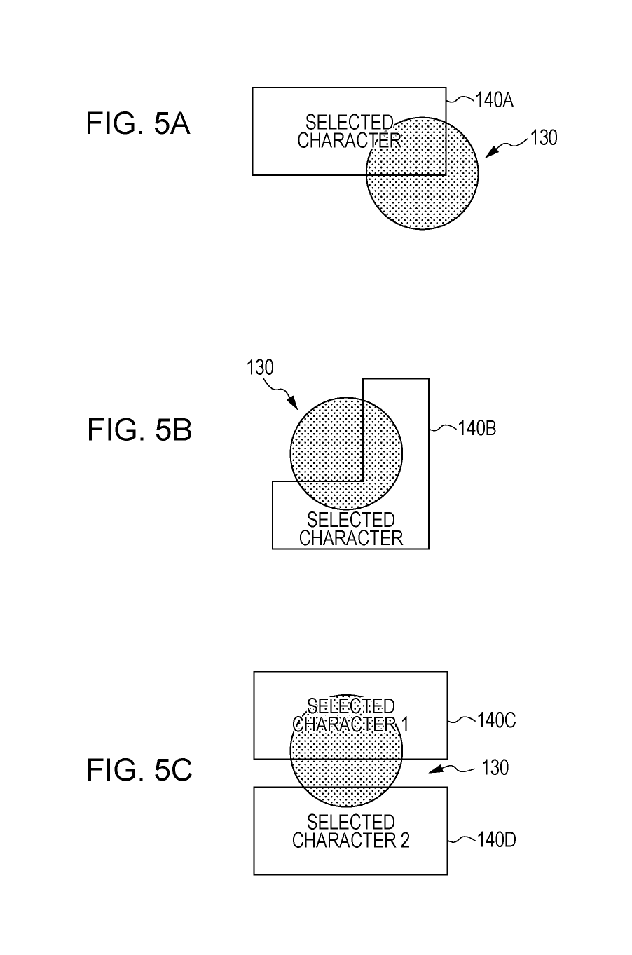

As shown in FIG. 5A, a case where an area of the touched region 130 overlapping with a region of a character input key 140A is less than 50% of the entire area of the touched region 130.

### Pattern 2

As shown in FIG. 5B, a case where an area center (center of gravity) of the touched region 130 is deviated from a region of a character input key 140B.

### Pattern 3

As shown in FIG. 5C, a case where the touched region 130 is overlapped with both of the character input key 140C and another character input key 140D.

It is to be noted that the pressed states where the incorrect input is caused by the above reasons are not limited to these three patterns.

If the reason of the incorrect input, which is specified by the incorrect input reason specification unit 30, is that the size of the character input keys 140 is small or the arrangement spaces therebetween are narrow, the incorrect input reason specification unit 30 transmits information for instructing enlargement display to the peripheral key enlargement display unit 50. On the other hand, even when the incorrect input judgment unit 24 judges that the input information is incorrect input, in a case where the pressed state of the character input keys 140 does not correspond to any of the above patterns 1 to 3, e.g., in a case where an area of the touched region 130 overlapping with the region of the character input key 140A is 50% or more of the entire area of the touched region 130, the information for instructing enlargement display is not transmitted to the peripheral key enlargement display unit 50. Therefore, the peripheral keys are not enlarged.

The peripheral key enlargement display unit 50 generates an image including the character keys 140 peripheral to the touched character input key 140N based on the information for instructing enlargement display, which is transmitted from the incorrect input reason specification unit 30. Then, the peripheral key enlargement display unit 50 displays the generated image on the display unit 12.

To be more specific, the enlarged region determination unit 52 refers to pressed position information relating to the position of the touched region 130, which is stored in the press information storage unit 40. Then, the enlarged region determination unit 52 determines a region of the character input keys 140 to be enlarged and displayed.

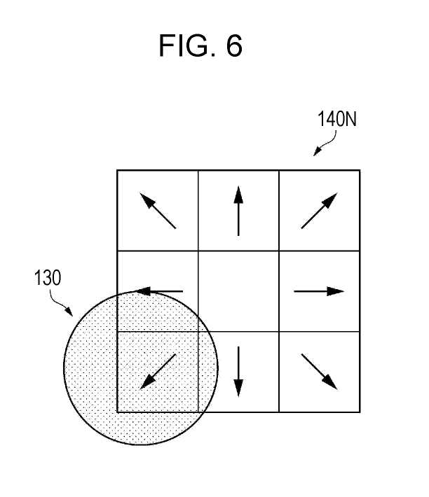

For example, as shown in FIG. 6, a region of the character input key 140N corresponding to the incorrectly input character (N) is divided into nine regions so as to specify a center of the touched region from the pressed position information. In this case, a region of which area overlapping with the touched region 130 is the largest is a lower left region. Therefore, the enlarged region determination unit 52 determines that a region including the character input keys 140 which are arranged at the lower left position with respect to the “N” key in the key input region 110 is an enlarged region. Information relating to the enlarged region determined by the enlarged region determination unit 52 is transmitted to the enlarged image generation unit 54.

The enlarged image generation unit 54 generates an enlarged image of the character input keys 140 including the “N” key based on the information relating to the enlarged region transmitted from the enlarged region determination unit 52 so as to display the generated enlarged region on the display unit 12. It is to be noted that the division number of the region of the character input key 140 is not limited to nine and the region of the character input key 140 having a rectangular shape may be divided into four regions with diagonal lines, for example. Further, the enlarged region determination unit 52 may determine the enlarged region such that the character input key 140N corresponding to the incorrectly input character “N” is positioned at a center of the enlarged image.

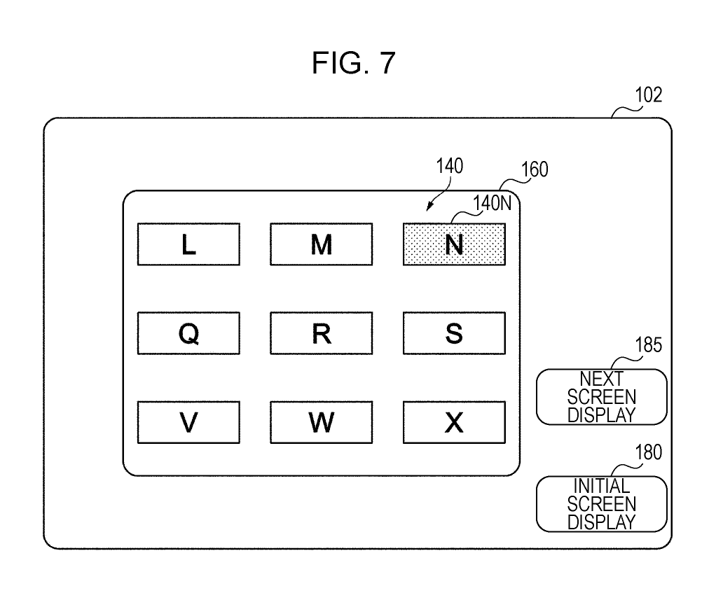

FIG. 7 is a diagram illustrating a key enlargement display screen 102 in which the enlarged image generated by the enlarged image generation unit 54 is displayed on the display unit 12. An enlarged key input region 160 is displayed at the center of the key enlarged display screen 102. Within the enlarged key input region 160, the character input keys 140 which are determined and arranged at the lower left region with respect to the “N” key in FIG. 6 are enlarged and displayed. That is to say, the “N” key which is the character input key 140N and is input incorrectly (N) is arranged at the upper right position. Further, the “S” key, an “X” key, the “M” key, the “R” key, a “W” key, an “L” key, a “Q” key and a “V” key which are arranged at the lower left position with respect to the “N” key are enlarged and displayed so as to be selected. At the same time, display spaces between the keys are enlarged. If any one of these keys displayed on the enlarged key input region 160 is touched, the touched key is selected and the screen returns to the initial screen 100. Then, a character corresponding to the touched key is added to the end of the character string on the display region 115.

Further, the next screen display key 185 and the initial screen display key 180 are displayed at the lower right position on the key enlargement display screen 102. If the next screen display key 185 is touched, a display content of the enlarged key input region 160 is sequentially changed in accordance with a predetermined rule. In this case, the character input keys 140 displayed on the enlarged key input region 160 may be changed in such a manner that the display region is moved in a specified direction from the keys on the initial screen 100. Further, an arrangement order of the character input keys 140 displayed on the enlarged key input region 160 may be changed.

In addition, an enlargement factor of the enlarged image may be changed when the next screen display key 185 is touched. That is, the enlarged image may be enlarged or minified. When the entire image of the keys are not kept in one screen, the image of the keys may be divided and one of the divided screens may be displayed. Then, when the next screen display key 185 is touched, other divided screens may be displayed.

If the initial screen display key 180 is touched, the initial screen 100 on which all the character input keys 140 are displayed is displayed on the display region of the touch panel input apparatus 11 in place of the key enlarged display screen 102. On the other hand, when any keys are not touched for a predetermined period of time, the initial screen 100 may be displayed on the assumption that the initial screen display key 180 is touched.

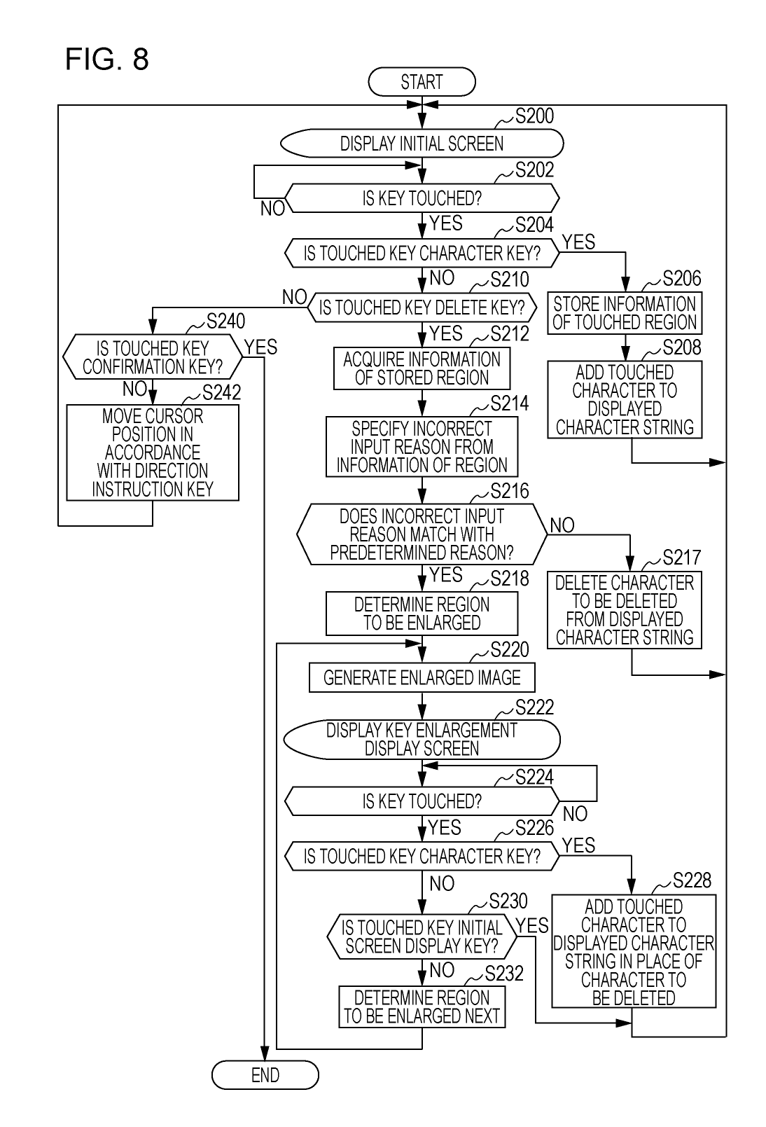

FIG. 8 is a flowchart illustrating a flow of processing in the information input apparatus 5. When a processing of the information input apparatus 5 is started, the CPU 80 displays the initial screen 100 on a display region of the touch panel input apparatus 11, at first (step S200 (hereinafter called as Sn, n=1, 2, 3 and so on)). Subsequently, the CPU 80 judges whether some key is touched by the user (S202). When any keys are not touched (No at S202), the step is repeated. On the other hand, when some key is judged to be touched (Yes at S202), the CPU 80 judges whether the touched key is the character input key 140 (S204).

At this time, when the touched key is judged to be the character input key 140 (Yes at S204), the CPU 80 stores information about the touched region (S206). Further, the CPU 80 adds a character corresponding to the touched character input key 140 to the end of a character string displayed on the display region 115 (S208). Then, the step returns to the step where the initial screen 100 is displayed (S200). On the other hand, when the touched key is not judged to be the character input key 140 (No at S204), the CPU 80 judges whether the touched key is the delete key 120 (S210) (incorrect input judgment step).

At this time, when the touched key is not judged to be the delete key 120 (No at S210), the CPU 80 judges whether the touched key is the confirmation key 125 (S240). When the touched key is judged to be the confirmation key 125 (Yes at S240), the character string displayed on the display region 115 is confirmed. Then, a series of the information input processing is terminated to proceed to the subsequent processing. On the other hand, when the touched key is not judged to be the confirmation key 125 (No at S240), the CPU 80 moves the position of the cursor 116 in the direction of the direction instruction key 128. Then, the step returns to the step where the initial screen 100 is displayed (S200).

Returning to S210, when the touched key 120 is judged to be the delete key 120 (Yes at S210), the CPU 80 acquires information about the stored region (S212). Then, the CPU 80 specifies a reason of the incorrect input from the acquired information (S214).

Subsequently, the CPU 80 judges whether the specified reason is a predetermined reason (S216) (incorrect input reason specification step). At this time, the predetermined reason is that the size of the character input keys 140 is small or the arrangement spaces therebetween are narrow. When the specified reason is not judged to be the predetermined reason (No at S216), the CPU 80 deletes the character to be deleted from the displayed character string (S217). Then, the step returns to the step where the initial screen 100 is displayed (S200).

On the other hand, the specified reason is judged to be the predetermined reason (Yes at S216), the CPU 80 determines a region to be enlarged by referring to the information about the stored region (S218) so as to generate an enlarged image (S220).

Next, the CPU 80 displays the key enlargement display screen 102 including the generated enlarged image on a display region of the touch panel input apparatus 11 (S222) (enlargement display step). Subsequently, the CPU 80 judges whether some key is touched by the user (S224). When any keys are not touched (No at S224), the step is repeated. On the other hand, when some key is judged to be touched (Yes at S224), the CPU 80 judges whether the touched key is the character input key 140 (S226).

At this time, when the touched key is judged to be any one of the character input keys 140 which have been enlarged and displayed (Yes at S226), the CPU 80 adds a character corresponding to the touched character input key 140 to the end of the displayed character string in place of the character to be deleted (S228). Then, the step returns to the step where the initial screen 100 is displayed (S200).

On the other hand, when the touched key is not judged to be the character input key 140 (No at S226), the CPU 80 judges whether the touched key is the initial screen display key 180 (S230).

At this time, when the initial screen display key 180 is judged to be touched (Yes at S230), the CPU 80 returns to the step where the initial screen 100 is displayed (S200). On the other hand, when the initial screen display key 180 is not judged to be touched (No at S230), the CPU 80 judges that the next screen display key 185 is touched. Then, the CPU 80 determines a region to be enlarged next (S232) and the process returns to the process where an enlarged image is generated (S220).

According to the above-described embodiment, when the character information is incorrectly input, the information input apparatus 5 specifies a reason of the incorrect input. When the specified reason is that the size of the character input keys 140 is small or the arrangement spaces therebetween are narrow, the information input apparatus 5 enlarges and displays the character input keys 140 peripheral to the selected character input key 140N on the display unit 12 so as to be selected. In other words, a case where the specified reason is that the size of the character input keys 140 is small or the arrangement spaces therebetween are narrow includes the following three patterns: a pattern where the area of the touched region 130 overlapping with the region of the character input key 140A is less than 50% of the entire area of the touched region 130; a pattern where an area center (center of gravity) of the touched region 130 is deviated from the region of the character input key 140B; and a pattern where the touched region 130 is overlapped with both of the character input key 140C and the character input key 140D. Accordingly, the character input keys 140 peripheral to the selected character input key 140N selected by a user are enlarged and displayed. At the same time, display spaces between the keys are enlarged. Therefore, the user can easily and reliably touch a desired key among the displayed character input keys 140.

What is claimed is:

1. An information input apparatus which displays a plurality of buttons on a display unit, detects an indicated position by a positional coordinate detection unit arranged on the display unit to input information corresponding to the indicated button, comprising:
an incorrect input judgment unit that judges whether information input when a first button among the plurality of buttons is indicated is incorrect input;
an incorrect input reason specification unit that specifies a reason of the incorrect input based on an indicated region of the first button with respect to an indicatable region of the first button displayed on the display unit, when the incorrect input judgment unit judges that the input information is the incorrect input; and
an enlargement display unit that enlarges and displays the buttons peripheral to the first button on the display unit in accordance with the reason of the incorrect input which is specified by the incorrect input reason specification unit,
wherein the indicatable region of the button is divided into a plurality of regions, and
the enlargement display unit selects the buttons peripheral to the first button in accordance with the region overlapping with the indicated region among the plurality of regions and enlarges and displays the selected buttons on the display unit.

2. The information input apparatus according to claim 1,
wherein when an area center position of the indicated region is not included in the indicatable region of the first button, the enlargement display unit enlarges to display the buttons peripheral to the first button on the display unit.

3. The information input apparatus according to claim 1,
wherein when the area center position of the indicated region is included in the indicatable region of the first button, the enlargement display unit does not enlarge to display the buttons peripheral to the first button on the display unit.

4. The information input apparatus according to claim 1,
wherein when the indicated region overlaps with the indicatable region of the first button and an indicatable region of another button, the enlargement display unit enlarges to display the buttons peripheral to the first button on the display unit.

5. The information input apparatus according to claim 1,
wherein when a ratio of an area of a region where the indicated region and the indicatable region of the first button are overlapped with each other with respect to an area of the indicated region is not larger than a predetermined ratio, the enlargement display unit enlarges to display the buttons peripheral to the first button on the display unit.

6. The information input apparatus according to claim 1, further comprising a storage unit that stores pieces of information relating to a plurality of the first buttons which are sequentially indicated among the plurality of buttons in chronological order.

7. An information input method which displays a plurality of buttons on a display unit, detects an indicated position by a positional coordinate detection unit arranged on the display unit to input information corresponding to the indicated button, comprising:
judging whether information input when a first button among the plurality of buttons is indicated is incorrect input;
specifying a reason of the incorrect input based on an indicated region of the first button with respect to an indicatable region of the first button displayed on the display unit, when the input information is judged to be the incorrect input in the incorrect input judgment; and
enlarging and displaying buttons peripheral to the first button on the display unit in accordance with the reason of the incorrect input which is specified by the incorrect input reason specification unit,
wherein the indicatable region of the button is divided into a plurality of regions, and
in the enlargement and display, the buttons peripheral to the first button are selected in accordance with the region overlapping with the indicated region among the plurality of regions and the selected buttons are enlarged and displayed on the display unit.
